(19) United States
(12) Patent Application Publication
(10) Pub. No.: US 2021/0279818 A1
(43) Pub. Date: Sep. 9, 2021

(54) SPLIT TESTING SYSTEM AND METHODS

(71) Applicant: Echobox Ltd, London (GB)

(72) Inventors: Antoine AMANN, London (GB); Marc FLETCHER, London (GB)

(73) Assignee: Echobox Ltd, London (GB)

(21) Appl. No.: 17/195,674

(22) Filed: Mar. 9, 2021

Related U.S. Application Data
(60) Provisional application No. 62/986,842, filed on Mar. 9, 2020.

(30) Foreign Application Priority Data
Mar. 9, 2020 (GB) 2003379.1

(51) Int. Cl. G06Q 50/00; G06F 3/0481; H04L 12/58; H04L 29/08

(52) U.S. Cl. CPC G06Q 50/01; H04L 67/22; H04L 51/32; G06F 3/0481

(57) ABSTRACT

A device for split testing a first object and a second object with a first group and a second group, comprising a split testing module. The split testing module is configured to arrange for the first object to be communicated to the first group and the second object to be communicated to the second group; arrange for the first object to be communicated to the second group and the second object to be communicated to the first group; obtain feedback data from each of the communications; and determine the performance of each object in dependence on the feedback data.

### RELATED APPLICATIONS

This application claims the benefit of priority of U.S. Provisional Patent Application No. 62/986,842 filed on Mar. 9, 2020 and United Kingdom Patent Application No. 2003379.1 filed on Mar. 9, 2020. The contents of the above applications are all incorporated by reference as if fully set forth herein in their entirety.

### FIELD AND BACKGROUND OF THE INVENTION

The present disclosure relates to split testing. The disclosure is particularly, but not exclusively, applicable to a method and system for split testing users interacting with two or more different versions of an object.

Designers are keenly interested in tracking how, and how frequently, users interact with the objects they have designed. Further, designers will have variations in the objects they design and they will want to know how end users use or engage with different variations. Some features might make users look at the object longer and other features might put users off. Some features might make users want to interact with it in different ways as compared with other features.

Split testing provides a way to present different objects to groups of people and record how and for how long they interact with different objects and different variations of objects.

Many companies limit the actions parties can take to observe how users interact with objects thus making testing how users interact with different object variations difficult or even impossible.

The present disclosure seeks at least to overcome the problems outlined above.

### SUMMARY OF THE INVENTION

Aspects of the disclosure are set out in the accompanying claims.

According to an aspect of the invention, there is provided a device for split testing a first object and a second object with a first group and a second group, comprising: a split testing module configured to: arrange for the first object to be communicated to the first group and the second object to be communicated to the second group; arrange for the first object to be communicated to the second group and the second object to be communicated to the first group; obtain feedback data from each of the communications; and determine the performance of each object in dependence on the feedback data.

Optionally, the feedback data is indicative of how often the objects were interacted with.

Optionally, the split testing module is further configured to obtain a number of times each object was interacted with.

Optionally, the interactions are remote interactions.

Optionally, the interactions are electronic interactions.

Optionally, the interaction is any one or more of the following: click, like, share, comment, and/or other user interaction.

Optionally, the interaction is a click.

Optionally, the split testing module is further configured to scale the number of times each object is interacted with during each communication.

Optionally, the split testing module is configured to determine a number of times each object was transmitted to and/or viewed by a member of a group.

Optionally, the number of times each object is interacted with during the communication is scaled by a number of times each object transmitted to and/or viewed by a member of a group.

Optionally, the feedback module is configured to determine a highest number of times each object was transmitted and/or viewed per group across all communications.

Optionally, the number of times each object is interacted with for each communication is scaled by a highest number of times each object was transmitted and/or viewed per group across all communications.

Optionally, the split testing module is configured to obtain a definition for a first group and a definition for a second group.

Optionally, the definitions are such that no members of the first group belong to that of the second group, and vice versa.

Optionally, the definitions are demographics.

Optionally, the split test module is configured to output which object performed better.

Optionally, the split test module is configured to arrange the communication of the object that performed better.

Optionally, the communication is to a social media platform.

Optionally, the second object is a variation of the first object.

Optionally, the device further comprises a presentation arrangement module and wherein the split testing module is configured to arrange the communication of the objects through use of the presentation arrangement module.

Optionally, the presentation arrangement module is configured to interface with a social media platform API.

Optionally, the presentation arrangement module is configured to obtain feedback data via a social media platform API.

Optionally, the object is a social media object.

Optionally, the first group and second group are remote to the device.

Optionally, each group comprises users remote to the device.

Optionally, each group comprises users remote to a social media platform communicating each object.

Optionally, the communication to each group is via a social media platform.

Optionally, only a subset of each group has an object communicated to it.

Optionally, the split testing module is configured to arrange to stop the first object being communicated to the first group and stop the second object being communicated to the second group.

Optionally, the split testing module is configured to arrange to stop the first object being communicated to the first group and stop the second object being communicated to the second group before arranging for the first object to be communicated to the second group and the second object to the first group.

Optionally, the split testing module is configured to arrange to stop the second object being communicated to the first group and stop the first object being communicated to the second group.

According to an aspect of the invention, there is provided a method of split testing a first object and a second object with a first group and a second group, comprising the steps: arranging for the first object to be communicated to the first group and the second object to be communicated to the second group; arranging for the first object to be communicated to the second group and the second object to the first group; obtaining feedback data from each the communications; and determining the performance of each object in dependence on the feedback data.

According to an aspect of the invention, there is provided a computer program product for conducting split testing based on a dataset when executed by a computer processor, cause the computer processor to carry out any aspect described herein.

According to an aspect of the invention, there is provided a device for conducting split testing, comprising a processor configured to undertake the method according to any aspect described herein.

It can also be appreciated that the methods can be implemented, at least in part, using computer program code. According to another aspect of the present disclosure, there is therefore provided computer software or computer program code adapted to carry out these methods described above when processed by a computer processing means. The computer software or computer program code can be carried by computer readable medium, and in particular a non-transitory computer readable medium. The medium may be a physical storage medium such as a Read Only Memory (ROM) chip. Alternatively, it may be a disk such as a Digital Video Disk (DVD-ROM) or Compact Disk (CD-ROM). It could also be a signal such as an electronic signal over wires, an optical signal or a radio signal such as to a satellite or the like. The disclosure also extends to a processor running the software or code, e.g. a computer configured to carry out the methods described above.

Each of the aspects above may comprise any one or more features mentioned in respect of the other aspects above.

Use of the words “server”, “device”, “processor”, “communication interface”, “module” and so on are intended to be general rather than specific. Whilst these features of the disclosure may be implemented using an individual component, such as a computer or a central processing unit (CPU), they can equally well be implemented using other suitable components or a combination of components. For example, they could be implemented using a hard-wired circuit or circuits, e.g. an integrated circuit, using embedded software, and/or software module(s) including a function, API interface, or SDK. Further, they may be more than just a singular component. For example, a server may not only include a single hardware device but also include a system of microservices or a serverless architecture. Either of which are configured to operate in the same or similar way as the singular server is described.

It should be noted that the term “comprising” as used in this document means “consisting at least in part of”. So, when interpreting statements in this document that include the term “comprising”, features other than that or those prefaced by the term may also be present. Related terms such as “comprise” and “comprises” are to be interpreted in the same manner. As used herein, “(s)” following a noun means the plural and/or singular forms of the noun.

The invention extends to methods and/or apparatus substantially as herein described and/or as illustrated in the accompanying drawings.

The invention extends to any novel aspects or features described and/or illustrated herein. In addition, device aspects may be applied to method aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

As used herein, means plus function features may be expressed alternatively in terms of their corresponding structure, such as a suitably programmed processor and associated memory, for example.

### BRIEF DESCRIPTION OF THE SEVERAL VIEWS OF THE DRAWINGS

FIG. 1 is a schematic diagram of a communication network according to a preferred embodiment of the disclosure.

FIG. 2 is a schematic diagram of a split testing server.

FIG. 3 is a schematic diagram of modules.

FIG. 4 illustrates a method of managing split tests.

FIG. 5 is a diagram illustrating example objects.

FIG. 6 illustrates example split testing stages.

FIG. 7 illustrates a method of checking and updating a split test.

FIG. 8 illustrates a method of updating a stage.

FIG. 9 illustrates a method of updating and conditionally marking a post as complete.

FIG. 10 illustrates a method of collating feedback data.

### DESCRIPTION OF SPECIFIC EMBODIMENTS OF THE INVENTION

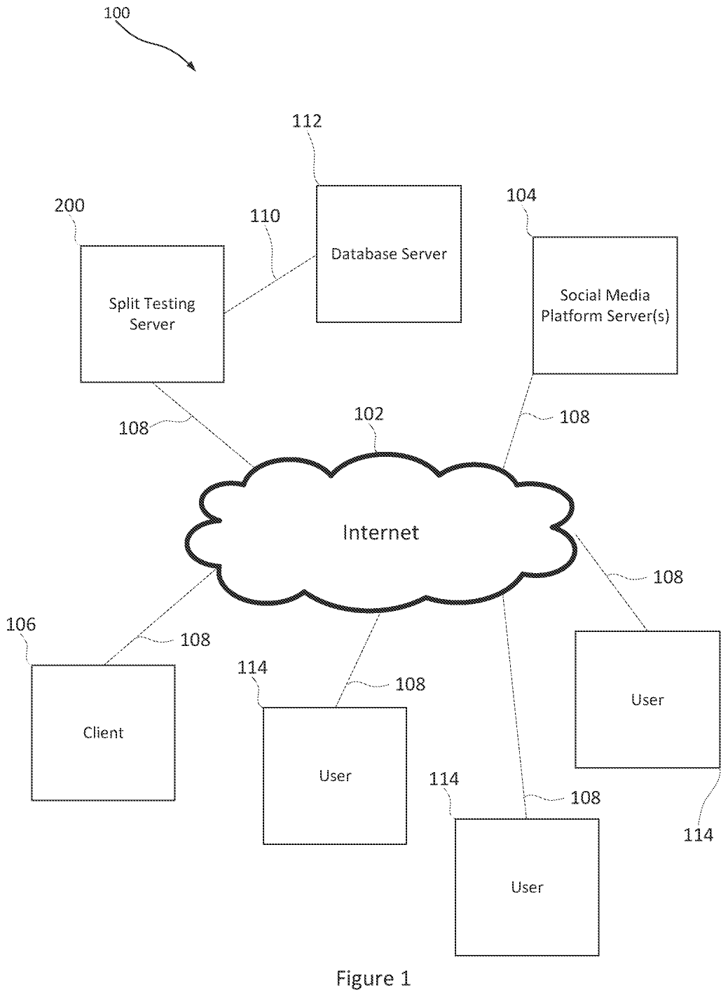

Referring to FIG. 1, in a communication network 100 a split testing server 200 is in communication with at least one social media platform server 104, a client 106, and a plurality of users 114 is shown. Communication between the different devices 200, 104, 106, 108 is made through the Internet 102 via communication links 108. The communication links 108 are standard Internet connections. Example communication links 108 are Ethernet connections to a router (not shown) and the router is connected to the Internet 102. The split testing server 200 is presented here as an example and the split testing described herein can equally be undertaken on any device with the same or similar components as the server 200.

The users 114 are remote to both the split testing server 200 and the social media platform server 104.

The split testing server 200 is connected to the social media platform server(s) 104 to run split testing via social media platforms. The split testing server 200 is connected to the database server 112 directly via connection 110. Optionally, connections to the database server are made over the Internet 102. The database server 112 in this example is a NoSQL server such as MongoDB. Alternatively the database server 112 is a relational database server such as PostgreSQL.

The client 106 is connectable to the split testing 200 so that the client 106 can provide their own objects for testing and/or modify their objects for testing on an interface provided by the split testing server 200.

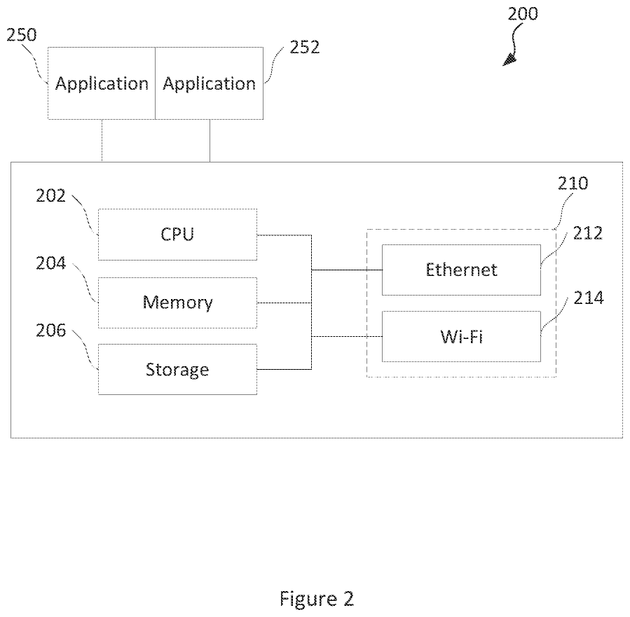

Referring to FIG. 2, the split testing server 200 comprises a Central Processing Unit (CPU) 202, memory 204, storage 206, communication interface 210 (comprising an Ethernet module 212 and optionally a Wi-Fi module 214) in communication with one another via a communication bus.

The CPU 202 is a computer processor, e.g. a microprocessor. It is arranged to execute instructions, e.g. in the form of computer executable code, and to process data, e.g. in the form of values and strings, including instructions and data stored in the memory 204 and the storage 206. The instructions and data executed by the CPU 202 include instructions for coordinating operation of the other components of the server 200, such as instructions and data for controlling the communication interface 210.

The memory 204 is implemented as one or more memory units providing Random Access Memory (RAM) for the server 200. In the illustrated embodiment, the memory 204 is a volatile memory, for example separate from the CPU 202. However, in other embodiments, the memory 204 is an on-chip RAM integrated with the CPU 202 using System-on-Chip (SoC) architecture. The memory 204 is arranged to store the instructions and data executed and processed by the CPU 202. Typically, only selected elements of the instructions and data are stored by the memory 204 at any one time, which selected elements define the instructions and data essential to the operations of the server 200 being carried out at the particular time. In other words, the instructions and data stored transiently in the memory 204 whilst some particular process is handled by the CPU 202.

The storage 206 is provided integrally with the server 200, in the form of a non-volatile memory. The storage 206, in most embodiments, is a hard drive. Alternatively the storage 206 is embedded on the same chip as the CPU 202 and the memory 204, using SoC architecture, e.g. by being implemented as a Multiple-Time Programmable (MTP) array. In further alternative embodiments, the storage 206 is an embedded or external flash memory, or such like. The storage 206 stores the instructions and data executed and processed by the CPU 202. The storage 206 stores the instructions and data permanently or semi-permanently, e.g. until overwritten. That is, the instructions and data are stored in the storage 206 non-transiently. Typically, the instructions and data stored by the storage 206 relates to instructions fundamental to the operation of the CPU 202, communication interface 210, and the server 200 more generally, including modules 216, 218, 220, and applications 250, 252 performing higher-level functionality of the server 200.

The communications interface 210 supports making and receiving connections to the Internet 102 usually via an Ethernet connection to an Internet connected router (not shown).

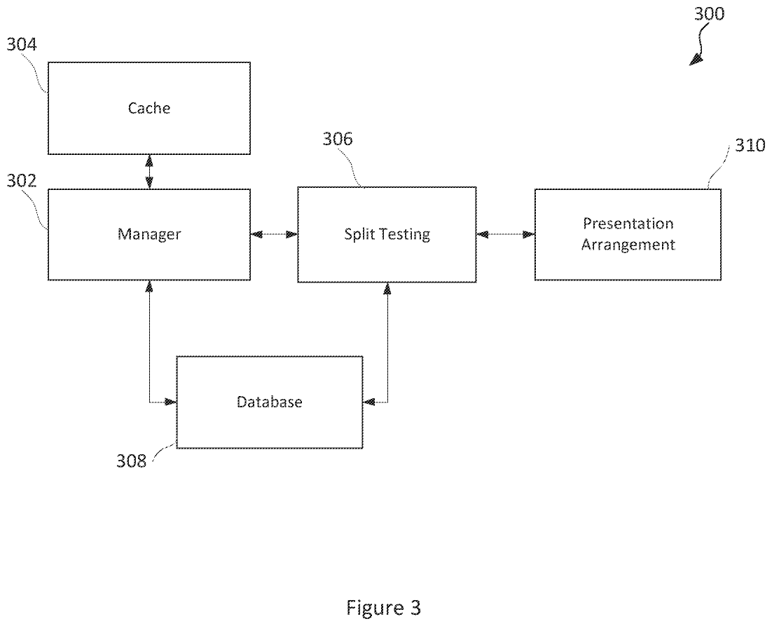

The server 200 is configured to run a plurality of software modules 300 as described with reference to FIG. 3. The software modules include an operating system. The operating system is an embedded or a real time operating system. Such operating systems are optimised to reduce delays and to allow for a better user experience. The operating system manages the basic functioning of the hardware of the server and operational interactions between the hardware components of the server and software modules.

The server 200 and software modules 300 are described as being configured to operate using Facebook™ “shares” by way of example only. Facebook™ is the social media platform owned by Facebook Inc. In particular, the primary example used herein is for testing two different shares on Facebook™ to see which one performs better. The tests are shown to two different groups of remote users 114 at different times, but then switched such that each group sees each share (although preferably a user 114 does not see both shares, as is discussed below). Once the tests have completed, usually after an elapsed time, the results are collected and a determination is made about which share performed better. The better performing share is then submitted to Facebook™ to be the final share on behalf of the client 106.

Software Modules

FIG. 3 shows a number of modules that run on the server 200. These modules 302, 304, 306, 308, 310 are software modules in the present example and are configured to communicate with each other as shown by the arrows. Alternatively, some modules are implemented in hardware. In a further alternative embodiment, the modules are software but configured to run on different server hardware or to communicate with different modules running on different server hardware.

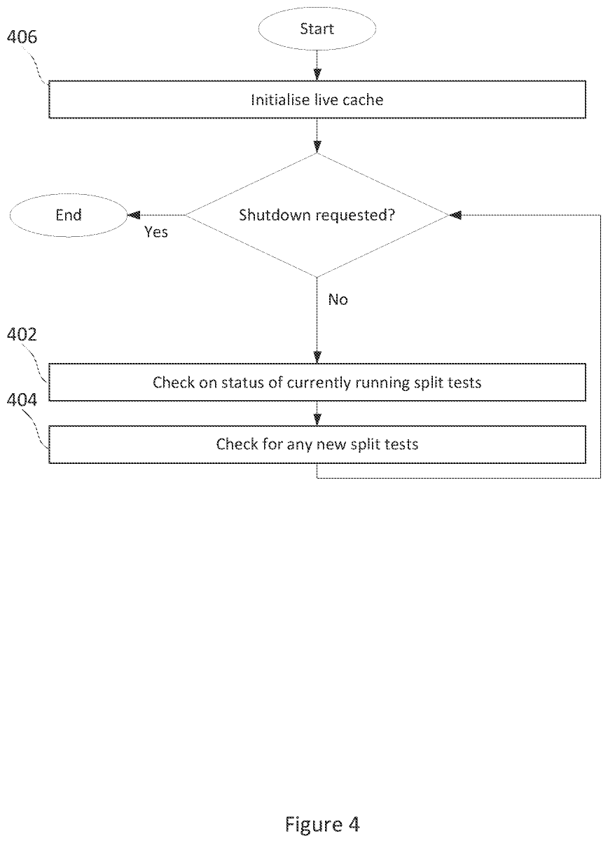

The manager module 302 is configured to manage coordinate the split testing on the server 200. In particular, the manager module 302 is configured to run the method 400 as described with reference to FIG. 4 below.

The cache module 304 is initialised by the manager module 302 as a cache of the database. Caching which split tests are currently being run results in fewer database calls, which are more computationally expensive and/or take a longer time. The cache module 304 also allows for data to be inserted with an associated recall time such that the manager module 302 is able to make calls into the cache for data that is ready to be used or checked again. This temporal feature is used so that data can be inserted into the cache, and recalled when it is appropriate to be checked again. For example, each test needs to be checked every so often to see whether it has completed or errored. The manager loop, discussed below, runs every second however checking every test every second would be a waste of resources. In particular, there is no point in checking if there are any insights or results available until after a period of time. After a split test is taken from the cache and checked, if the test hasn't completed, it is added back into back into the cache with a particular time in the future such that it won't be checked again until ready.

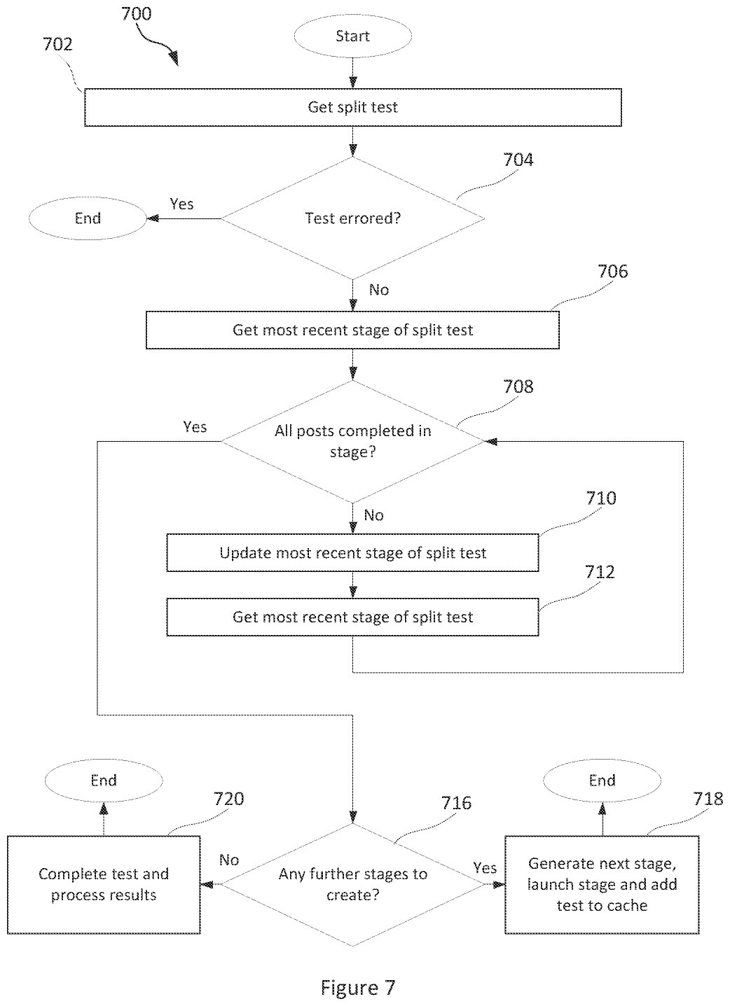

This checking process is also described in context later with reference to FIG. 7.

The manager 302 calls functions in the split testing module 306 to create and run the split tests. The split testing module 306 comprises all of the code and data required to create posts, coordinate obtaining feedback data, interpret feedback data, filter feedback results, ensure testing is running correctly, instruct the presentation arrangement module 310 to post the social media posts, create demographic groups, and more.

In the present example, the manager 302 generates task lists involving functions in the split testing module 306. These task lists are executed using an asynchronous execution method. In particular, Java's ExecutorService is used. Alternative asynchronous execution methods include threading modules, other processes being created via fork and exec, or similar. Alternatively, the task lists may be executed using a synchronous execution method.

The database module 308 in the present example is configured to establish a connection to an external database server 112. The database module 308 comprises hardware and/or software components that are required to establish said connection. Alternatively the database module 308 is only software and uses the hardware components already present on the server 200. In a further alternative, the database is running on the server 200 itself and the database module 308 is configured to manage inter-process communication with said database software. The inter-process communication may be TCP/IP. In a further alternative, the database module 308 is software library configured to manage the database itself such as an SQLite database and associated libraries. A person skilled in the art will appreciate that there are a number of different database setups and an even greater number of ways to connect to said database setups.

The presentation arrangement module 310 is configured to arrange the communication of each object to each group according to the split testing module 304. The arrangement of communication to each group results in the social media platform transmitting the object(s) to members of the groups. Once transmitted, the objects will likely be viewed by the users of the groups. In the present social media example, the presentation arrangement module 310 is used to conduct the API interactions with the social media network's server(s) 104 in question. In particular, the presentation arrangement module 310 is configured to handle the sending and receiving of data to Facebook's™ servers 104. Both the group definition(s) and object(s) are provided by the split testing module 304.

Other social media platforms such as Twitter™, Instagram™, and LinkedIn™ and similar are used in addition or alternatively.

The same or similar methods of the split testing module 304 may be used with different platforms by configuring the presentation arrangement module 310 to interface with other platforms.

Manager Loop

Referring to FIG. 4, a method 400 is depicted that the manager module 302 uses to manage the split testing. The method comprises a loop that is run every second. Inside the loop, there is a check 402 on all currently running split tests to make sure they are still running correctly. The check 402 includes gathering any data that may be available regarding the test status, and updating the test if anything has changed. In this example, the check, as discussed briefly above, is not actually conducted in the loop but rather asynchronously. The check step 402 establishes a list of tasks to run, then runs the tasks asynchronously to the main manager loop. Advantageously, running these tasks asynchronously allows the system to more easily scale when the number of tests running concurrently expands. Scaling is possible by simply adding more computing cores or concurrent computing power generally. Alternatively, the check step 402 checks through all of the running tests one after the other.

An example check step 402 is shown and described with reference to FIG. 7 below.

Also inside the loop is a check 404 to see whether there are any new split tests in the database that need to be created. As this new test check 404 for new tests requires database access, the checks are not run every loop so as to not lock the database for needlessly frequently. In this example, the new test check 404 is only run every 20 seconds.

The loop is run every second by subtracting the time elapsed to run the checks 402, 404 from 1 second and waiting that long. If the checks take longer than 1 second, then the loop re-runs immediately.

New split tests are added by clients into the database via an interface provided by the server 200. The interface may be an HTML interface and/or API.

If new split tests are present then the manager module 302 uses the split test module 304 to initialise them and run them.

Before entering the loop, the cache 304 is initialised 406. The cache 304 is initialised with all split tests present in the database.

Split Testing

As mentioned above, while Facebook™ shares are used as the main example, a person skilled in the art will appreciate that the methods described here will equally apply to other social media messages, advertisements, other online media a user wishes to test for engagement, and non-Internet related objects. The Facebook™ shares are a specific example of objects.

The methods, systems, and servers described herein are able to use different platforms (social media or otherwise) for split testing even when said platforms do not provide a split testing system built in. The platform need only provide a way to segment which users are able to view objects and obtain feedback data for each group. As long as the presentation arrangement module 310 is configured to interface with the platform, split testing can be conducted.

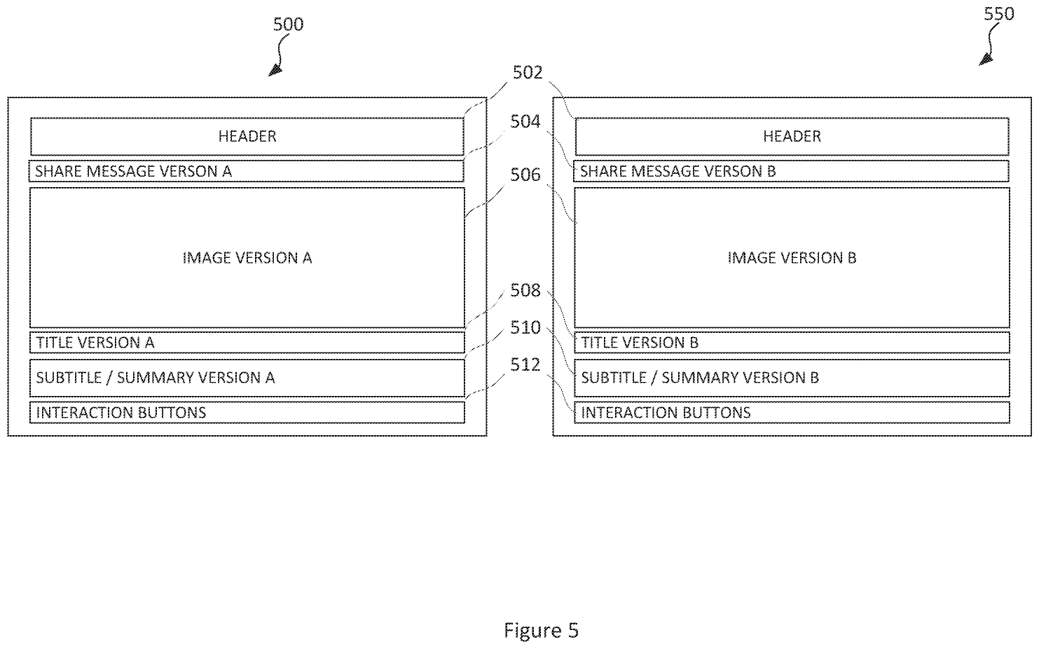

Referring to FIG. 5, example Facebook™ shares 500, 550 are shown. Each object's 500, 550 components have been numbered such that the items that are substantially the same have the same reference numeral. As is shown in FIG. 5 and discussed below, most of the object can be customised. The objects for split testing shown here have a version A and version B for share message 504, image 506 (or video in other cases), title 508, and subtitle 510. The system can equally handle fewer variations if, for example, the user wanted to only compare how different images 506 changed user interaction and they wanted to keep the other features the same. Further, the system can handle more than two variations at a time. For example if there were three different images 506 to be tested then a third Version C would be used.

The different objects in the present example are described and stored as entirely separate objects, even though may be substantially similar. Alternatively, a first object is stored and only the differences are stored for each variation.

The objects 500, 550 are provided by way of example and relate to Facebook™. Other platforms will have different objects and comprise different contents generally.

Each Facebook™ object comprises a header 502 which contains information detailing who the object is made or posted by, that it is sponsored and whether a social media user has liked the page or not. The header 502 is not usually customisable. Each object similarly has a share message 504 that appears separate from the link or content being shared. This message 504 is customisable by the user. The object presented comprises a hyperlink to further content, an image 506 or video, title 508, and/or subtitle 510 (or summary in some cases) all of which may be customised by the user. The hyperlink is embedded into the object such that when a user clicks on any of the image 506, title 508, or subtitle 510, the browser takes them to the hyperlink provided. The hyperlink may also be customised per object so that the split testing module can check which object the click came from. Facebook™ does provide said click through data, however using a custom URL per object variation may be used in the case the user wants their own Facebook™ independent click through rates.

The interaction buttons 512 for Facebook™ include the Like, Comment, and Share buttons and occasionally statistics on the number of likes, comments, and shares. The interaction buttons 512 are uncustomisable usually.

In the two object case, there are two stages comprising of two posts each. This gives four posts total. Each post comprises the object variation and indicator of group the object variation will be shown to. While the split testing is running, the post later will also have associated feedback data.

Membership of a group is such that a member of a first group cannot be a member of a second group, and vice versa. A group definition is used to determine who is a member of each group.

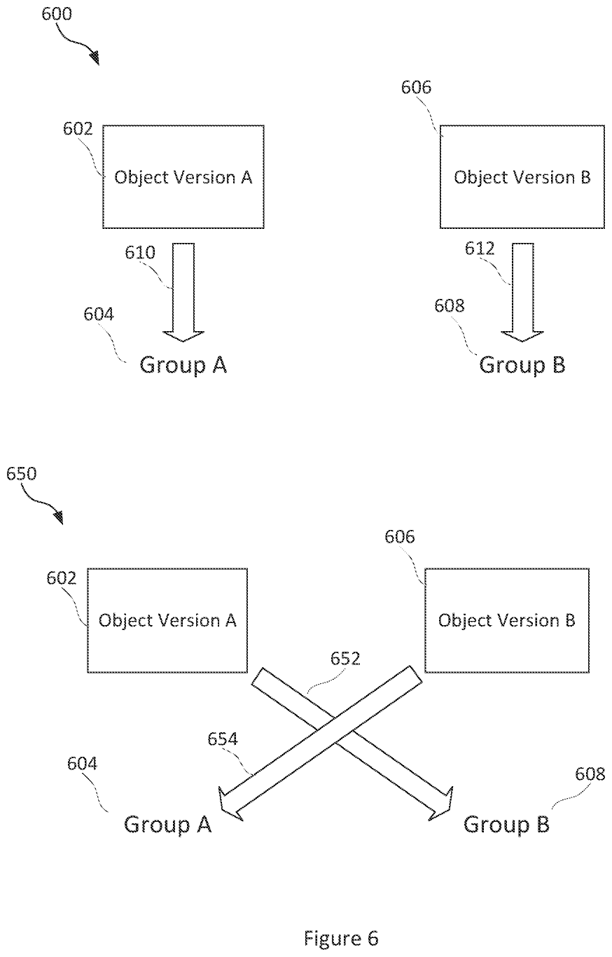

The groups are determined by a demographic. Demographics are selected such that when a population (partial or total) is split into groups there will be no members that belong to both groups. Membership of only one group is important and described below with reference to FIG. 6 to ensure statistical biases in the split testing are reduced.

As mentioned above, the split test module 304 is configured to obtain new split tests from the database module 308 when the manager module 302 determines there is a new split test to run. A new split test obtained by the split test module 304 comprises at least two objects to test. The split test module 304 is configured to arrange different stages according to the number of objects to test.

Referring to FIG. 6, two stages 600, 650 are shown. In the first stage 600, version A of the object 602 is shared with group A 604 and version B of the object 606 is shared with group B 608. The first stage 600 comprises two posts 610, 612. The second stage 650 also comprises two posts 652, 654. The posts 610, 612, 652, 654 are represented by arrows and as discussed above. The post comprises information of the group to deliver it to along with information indicative of the object to be shared with the given group.

The posts are sent by the split testing module 306 to the social media platform via the presentation arrangement module 310.

As discussed above, the objects are arranged to be presented to different groups such that the same user does not get shown both versions at the same time. Showing the same person both versions may affect the statistical validity of the results as a first viewing may affect a second one. Presenting the different object variation to different and non-overlapping groups in the first stage 600 therefore will mean that no one will have an opportunity to interact with both variations at the same time.

There may possibly be biases between groups however. For example, if group A are simply more likely to interact with an object because of something inherent regarding their membership of group A, then the results obtained relating to any object presented to group A will be skewed higher. To reduce this bias, the groups and objects are shuffled such that members of group B will have an opportunity to interact with object A initially and vice versa. This is shown in the second stage 650.

By running the first stage 600 and the second stage 650 at different, non-overlapping times (sequentially in the present example), the chance of a specific member being presented both versions of the object are reduced.

While a two object example is used in this specification, more objects can be used. Having more objects is achieved by ensuring that all groups have each variation present. Matching groups to objects can be achieved using any appropriate shuffling and/or matching algorithm or table. More stages are required so that a group is never presented more than one object at any one time. An example table for 3 objects can be seen in Table 1.

TABLE 1
A Three Object Split Test Example

| | Object A | Object B | Object C |
|---|---|---|---|
| Stage 1 | Group A | Group B | |
| Stage 2 | | Group A | Group B |
| Stage 3 | Group B | | Group A |

An alternative to the two (or more) group system as shown in FIG. 6, is a system that does not use groups. In this alternative, the number of posts equal the number of variations. Continuing with the two variation example, the first post is the first object and is shared to the unsegmented, ungrouped, total population of users 114, and the second post is the second object and is also shared to the unsegmented, ungrouped, total population of users 114. The posts are made sequentially. This alternative system is used when demographic (or other) targeting is not possible. While it does introduce the possibility of some bias, in some situations, the bias is minimal and not significant to the overall process.

Referring to FIG. 7, a method 700 of updating and checking whether a split test has completed is shown. As mentioned above, the method 700 is run as part of the manager loop 400. The steps of this method 700 are run per split test currently running.

The first step 702 is to obtain the split test from the database so that different features of the split test can be checked and/or updated.

The first check 704 is to see whether an error has occurred in the split test. If so, the test will not continue to be processed. A log is made of the error and a further process will clean the test up.

Next, the latest stage of the AB test is obtained 706 and checked 708 as to whether it has completed. If it has not completed, then it is updated 710. The update 710 may result in the stage being completed. The latest stage is obtained 712 again and checked 708 again to see whether all of the posts have completed in the stage. The latest stage obtained 712 will be the same one that was just updated 710. The latest stage may not need to be obtained 712 and alternatively a reference to the same stage is stored such that the reference to the post is used to check 708 on whether all of the posts associated with it have completed.

In an alternative (not shown in FIG. 7), if all of the posts have not completed at a check 708, then the split test may be added back into the cache 304, rather than the method proceeding straight to update 710 of the most recent stage, optionally with a 60 second timer such that it will be checked again in approximately 60 seconds. The split test may be added back to the cache 304 with a time between 5 seconds and 5 minutes, preferably between 15 seconds and 4 minutes, more preferably between 30 seconds and 3 minutes, even more preferably between 45 seconds and 2 minutes, yet more preferably approximately 60 seconds, and most preferably 60 seconds.

If all of the posts have completed, then a check is made as to whether there are more stages to create. The check 716 is conducted by comparing the total number of stages completed to the total number of stages expected. The total number of stages expected is based on the number of object variations and/or number of groups. In the example of two variations, there are two stages (as shown in FIG. 6).

If there are more stages to complete, then the next stage is generated and launched and then the split test is added 718 back to the cache 304. When a new stage is created and launched, a period of time is waited before checking for any insights or feedback results. On Facebook™ it usually takes 5 minutes to obtain insights.

The waiting period is between 1 minute and 15 minutes, preferably between 2 and 10 minutes, more preferably between 3 minutes and 7 minutes, yet more preferably between 4 and 6 minutes and most preferably 5 minutes.

An additional buffer of time is added. Preferably the buffer is 30 seconds of time. Therefore the final timeout of 5 minutes and 30 seconds is used to wait for feedback data to become available is most preferable including the buffer.

If there are no more stages, the split test is marked as complete and the feedback results are processed 720. Finally the system determines which variation performed better. The better variation is outputted.

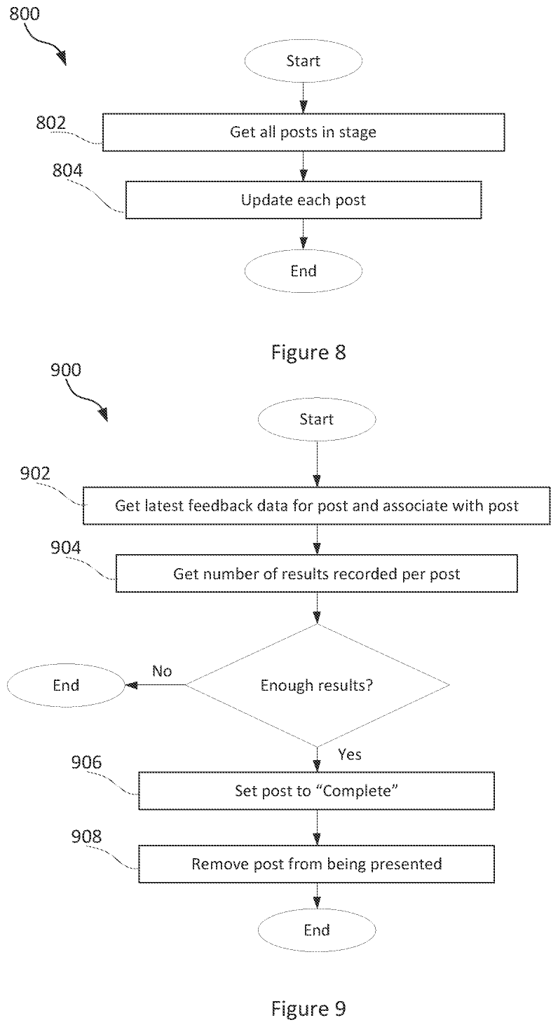

Referring to FIG. 8, an example method 800 of updating a stage is shown. This method is optionally used to update 710 the most recent stage as in the method described with reference to FIG. 7. In this case, the split testing module 304 calls this method 800 asynchronously using the Java Executor Service.

Updating a stage according to this method 800 involves updating each post within the stage. The process using this method 800 will determine when the stage has completed.

The first step 802 is to get all of the posts associated with the stage and then update 804 them. The update step is optionally run asynchronously using the Java Executor Service. Each post is updated according to the method 900 as discussed with reference to FIG. 9.

Referring now to FIG. 9, a method of updating and conditionally marking a post as complete is shown.

The latest feedback data related to the post is obtained 902 firstly. The feedback data is obtained using the presentation arrangement module 310 which interfaces with the social media platform. In the Facebook™ example, the feedback data is called “insights”. The feedback data comprises information on how many users saw, clicked, liked, shared, commented, or otherwise interacted with it. The feedback data is used to determine how well the post performed.

In the present example, feedback data is collected a number of times until the data collected is considered reliable. The number of times feedback data is collected may be between 1 and 5, preferably between 2 and 4, and most preferably 3. This is to ensure there is enough data for the test to be statistically significant. Three collections of feedback data means each post has approximately 15 minutes of total time of viewing. This is because the feedback data is collected every approximately 5 minutes, as discussed above.

The feedback data comprises what interactions have occurred since the post started being presented.

If not enough feedback data has been collected yet, then the update finishes and the stage will continue to be processed as described with reference to FIG. 7 at a later stage.

If enough feedback data has been collected, then the post is set 906 to complete and then the post is put 908 in a state such that it cannot be viewed by any groups. In particular, the presentation arrangement module 310 is used to remove the post completely from Facebook™. Optionally, any final results that might've come through between collecting the latest feedback data and preventing the post from being viewed are also collected. Optionally, preventing the post from being viewed means removing it from the platform entirely. Optionally, removing the post includes capturing the final feedback data from it.

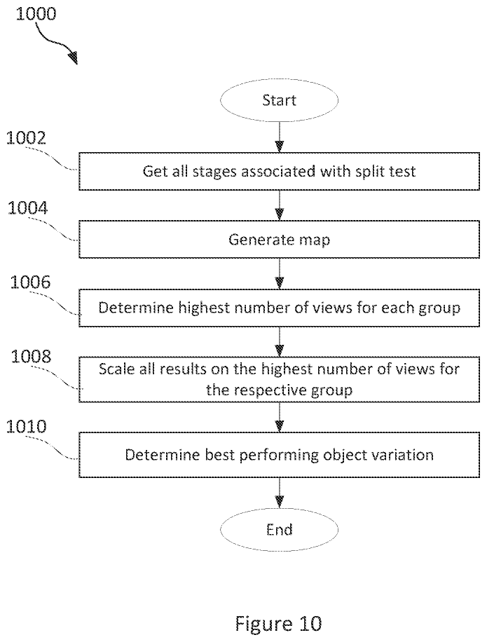

Referring to FIG. 10, a method 1000 of processing and collating the feedback data collected across all of the posts is shown. Optionally, the feedback data processing step 720 as described in method 700 uses this method 1000 presented here in FIG. 10. The output of this method 1000 is the object that performed best.

All of the stages associated with a completed split test are obtained 1002.

A map is generated 1004 with the group identifier as the key and a feedback data point as the value. The group identifier in this example is an encoding of the demographic used. An example feedback data point is the number of times the post has been viewed by and/or transmitted to a member of the group. Each post is iterated over to determine 1006 the highest number of views and/or transmissions for each group across all posts.

All of the results obtained are then scaled 1008 by the highest views and/or transmissions obtained for each group. The scaling is done to normalise the results. The normalisation is to prevent the case where if one post happened to have a much larger audience by chance. A larger audience would likely get an increased amount of interaction simply by the fact more people had seen it or otherwise had the object transmitted to them. The proportion of users that have interacted with the post, not the total number, is what is used to determine which object performed better.

The scaled feedback data are then used to determine 1010 which object performed better. All of the scaled feedback data are iterated over summed per object. The object with the highest total scaled interactions is selected as the best performing object. In this Facebook™ example, the highest number of clicks is used to determine the best performing object. Alternatively, the number of clicks, likes, shares, and comments are all used to determine which post performed better. A weighting for each of clicks, likes, shares, and comments and then summation of the weighted results is used.

The split test is complete with the best object finally determined.

Preferably, the split test module 306 is configured to take the best object and post that to Facebook™ via the presentation arrangement module 310.

Optionally, the best object is then outputted by the split test module 306.

The described embodiments of the invention are only examples of how the invention may be implemented. Modifications, variations and changes to the described embodiments will occur to those having appropriate skills and knowledge. These modifications, variations and changes may be made without departure from the scope of the claims.

What is claimed is:

1. A device for split testing a first object and a second object with a first group and a second group, comprising:
a split testing module configured to:
arrange for the first object to be communicated to the first group and the second object to be communicated to the second group;
arrange for the first object to be communicated to the second group and the second object to be communicated to the first group;
obtain feedback data from each of the communications; and
determine the performance of each object in dependence on the feedback data.

2. The device of claim 1, wherein the feedback data is indicative of how often the objects were interacted with.

3. The device of claim 1, wherein the split testing module is further configured to obtain a number of times each object was interacted with.

4. The device of claim 3, wherein the interaction is any one or more of the following: click, like, share, comment, and/or other user interaction.

5. The device of claim 3, wherein the interaction is a click.

6. The device of claim 3, wherein the split testing module is further configured to scale the number of times each object is interacted with during each communication.

7. The device of claim 6, wherein the split testing module is configured to determine a number of times each object was communicated to and/or viewed by a member of a group.

8. The device of claim 6, wherein the number of times each object is interacted with during the communication is scaled by a number of times each object was communicated to and/or viewed by a member of a group.

9. The device of claim 6, wherein the number of times each object is interacted with for each communication is scaled by a highest number of times each object was communicated and/or viewed per group across all communications.

10. The device of claim 1, wherein the split testing module is configured to obtain a definition for a first group and a definition for a second group.

11. The device of claim 10, wherein the definitions are such that no members of the first group belong to that of the second group, and vice versa.

12. The device of claim 10, wherein the definitions are demographics.

13. The device of claim 1, wherein the split testing module is configured to output which object performed better.

14. The device of claim 1, wherein the split testing module is configured to arrange for the communication of the object that performed better.

15. The device of claim 14, wherein the communication is to a social media platform.

16. The device of claim 1, wherein the second object is a variation of the first object.

17. The device of claim 1, further comprising a presentation arrangement module and wherein the split testing module is configured to arrange for the communication of the objects through use of the presentation arrangement module.

18. The device of claim 1, wherein the split testing module is configured to arrange to stop the second object being communicated to the first group and stop the first object being communicated to the second group.

19. A method of split testing a first object and a second object with a first group and a second group, comprising the steps:
arranging for the first object to be communicated to the first group and the second object to be communicated to the second group;
arranging for the first object to be communicated to the second group and the second object to the first group;
obtaining feedback data from each the communications; and
determining the performance of each object in dependence on the feedback data.

20. A computer program product for split testing which, when executed by a computer processor, causes the computer processor to carry out the method of claim 19.
